(19) United States
(12) Patent Application Publication
(10) Pub. No.: US 2002/0131816 A1
(43) Pub. Date: Sep. 19, 2002

(54) Locking ring and method for securing a control rod drive housing tube nut of a nuclear power plant

(76) Inventors: Josef Forster, Hirschaid (DE); Georg Gebald, Kirchehrenbach (DE); Alexander Hummeler, Rottenbach (DE); Hartmut Lelickens, Wiesenthau (DE); Konrad Meier-Hynek, Herzogenaurach (DE)

Correspondence Address: LERNER AND GREENBERG, P.A., Post Office Box 2480, Hollywood, FL, 33022-2480, US

(21) Appl. No.: 10/012,172

(22) Filed: Oct. 29, 2001

Related U.S. Application Data
(63) Continuation of application No. PCT/DE00/01205, filed on Apr. 17, 2000.

(30) Foreign Application Priority Data
Apr. 29, 1999 (DE) 199 19 619.2

(51) Int. Cl. B25G 3/34

(52) U.S. Cl. 403/271

(57) ABSTRACT

A locking ring holds a control rod drive housing tube of a nuclear power plant when a pressure chamber having a contact wall is pressurized. The contact wall faces the control rod drive housing tube presses against it when the pressure chamber is pressurized. The locking ring can lock a threaded nut after it has been screwed onto the control rod drive housing tube. In a method for securing a threaded nut of a control rod drive housing tube of a nuclear power plant in the vicinity of the threaded nut, a body is attached to the control rod drive housing tube, as a result of a contact surface of the body engaging the control rod drive housing tube. A contact surface of the pressure chamber is pressed onto the control rod drive housing tube when the pressure chamber is pressurized.

### CROSS-REFERENCE TO RELATED APPLICATION

This application is a continuation of copending International Application No. PCT/DE00/01205, filed Apr. 17, 2000, which designated the United States.

### BACKGROUND OF THE INVENTION

### Field of the Invention

The invention relates to a locking ring that is to be pushed onto a control rod drive housing tube of a nuclear power plant. The invention also relates to a method for securing a threaded nut of a control rod drive housing tube of a nuclear power plant.

According to a customary procedure, a locking ring can be secured to a workpiece by initially heating the locking ring and then pushing it in the heated state onto the cooler workpiece. When the locking ring cools, with the associated shrinkage of the locking ring, it is pressed onto the workpiece and is therefore locked onto the latter. Such a procedure is not possible when working under water, for example in a reactor pressure vessel, because the locking ring needs to be heated.

German published, non-prosecuted application no. DE 44 30 535 A1 discloses a device for axially mounting a hub component on a shaft. This device uses a locking ring that is constructed as a double-walled sleeve with an inner pressure chamber. A locking ring of this type can only be produced with considerable outlay.

In a boiling water nuclear reactor, the control rods are introduced into the interior of the reactor pressure vessel through nozzles disposed on the underside of the reactor pressure vessel. A control rod drive housing tube is welded into each of the nozzles, and a control rod with a control rod guide tube is inserted into each control rod drive housing tube. The nozzles and the control rod drive housing tubes are vertically oriented.

For reasons of redundant safety, the control rod drive housing tubes are each secured by a drive housing tube nut. The drive housing tube nut surrounds the control rod drive housing tube, and is screwed onto an external screwthread of this tube. Its underside rests on the top edge of the respective nozzle of the reactor pressure vessel, thus preventing the control rod drive housing tube in question from leaving its installed position and being forced out of the nozzle in the postulated event of failure or fracture of the respective weld seam produced by the pressure prevailing in the interior of the reactor pressure vessel.

The drive housing tube nut can be secured against rotation and loosening by a cylindrical pin. For this purpose, the cylindrical pin is pushed through a bore, which runs parallel to the control rod drive housing tube, in the drive housing tube nut until a part of the cylindrical pin which projects beyond the bore latches into a blind hole on the nozzle.

The securing function of the drive housing tube nut with a rigid cylindrical pin of this type may deteriorate, in particular, after the reactor has operated for many years. The vibrations of the reactor pressure vessel while it is operating, caused by minor installation defects that may be present or by expansion that occurs while the reactor is operating on account of temperature differences, could lead to the cylindrical pin becoming diverted or even detached, with the result that after a certain time the drive housing tube nut would also become movable and therefore detachable.

In the event of the cylindrical pin and possibly also the drive housing tube nut becoming detached, it is not readily possible to retrofit a new cylindrical pin with a new drive housing tube nut because the control rod drive housing tubes are disposed on the underside of the reactor pressure vessel and consequently can only be reached with difficulty. It is therefore virtually impossible to dispose a new bore for a new cylindrical pin at the locations with an acceptable time outlay.

### SUMMARY OF THE INVENTION

It is accordingly an object of the invention to provide a locking ring and method for securing a control rod drive housing tube nut of a nuclear power plant that overcomes the hereinafore-mentioned disadvantages of the heretofore-known devices of this general type and that can be produced in a simple way. The locking ring also can quickly and easily secure a loose or loosened drive housing tube nut, for example as part of a refit, to prevent the loose or loosened drive housing tube nut from becoming detached or moving.

With the foregoing and other objects in view, there is provided, in accordance with the invention, a locking ring for pushing onto a control rod drive housing tube of a nuclear power plant. The locking ring includes a first part-ring and a second part-ring welded together to form a pressure chamber to which pressure can be applied. A contact wall has an outer side facing the control rod drive housing tube and is pressed onto the control rod drive housing tube by the pressure. The pressure chamber adjoins the contact wall and withstands pressures greater than 1000 bar.

With the objects of the invention in view, there is also provided a method for securing a threaded nut of a control rod drive housing tube of a nuclear power plant. The first step of the method is permanently attaching a body to the control rod drive housing tube near the threaded nut. The next step is engaging a contact surface of the body around the control rod drive housing tube. The next step is exposing a pressure to chamber in the body to pressure to press the contact surface onto the control rod drive housing tube at least at certain locations.

With regard to a locking ring of the type described in the introduction, the object is achieved by assembling the locking ring from a first part-ring and a second part-ring, forming a pressure chamber that can be exposed to pressure. The pressure chamber adjoins a contact wall. The outer side of the contact wall can face toward the control rod drive housing tube and can be pressed onto the control rod drive housing tube under the influence of the pressure.

The locking ring may be pressed onto the control rod drive housing tube either indirectly or directly. It is constructed in particular as a hollow metallic ring.

When the pressure chamber is exposed to pressure, the contact wall, which is configured, for example, as an annular wall, can be deformed elastically and/or plastically. The locking ring is dimensioned in such a manner that, during this deformation, the contact wall is pressed onto the control rod drive housing tube. The control rod drive housing tube, together with the locking ring, is deformed elastically as a result of great pressure and, if the pressure is suitably high, is also deformed plastically. After the load on the pressure chamber has been relieved, some of the elastic deformation can spring back. However, at least a residual deformation remains, which securely joins the locking ring and the control rod drive housing tube to one another. The join may be positively and/or non-positively locking.

The locking ring has the advantage that no temperature difference between the ring and control rod drive housing tube is needed for its installation. Consequently, a locking ring of this type can be fitted even under water.

The locking ring allows a drive housing tube nut of a nuclear power plant to be locked and retrofitted without problems.

According to a preferred configuration, the wall thickness of the contact wall is less than the wall thicknesses of the other walls of the pressure chamber. This has the advantageous result that the pressure in the pressure chamber primarily causes deformation of the contact wall, so that the contact wall is pressed particularly strongly onto the control rod drive housing tube.

The locking ring preferably has a profiling, in particular a knurling, which comes to lie between the contact wall and the control rod drive housing tube. As a result, the strength of the locking connection that is produced between the locking ring and the control rod drive housing tube after pressure has been applied to the pressure chamber is increased.

As an alternative or in addition to a profiling of this type, the locking ring preferably has a molded projection, in particular a lug that comes to lie between the contact wall and the control rod drive housing tube.

The profiling and/or the molded projection generate a particularly high local pressure on the control rod drive housing tube and consequently dig into the surface of this tube.

In order for the pressure chamber to be filled with a fluid, in particular with a hydraulic fluid, the locking ring has, for example, a filling flange that is able to withstand high pressure.

According to a preferred refinement, the locking ring includes a spring element that comes to lie between the contact wall and the control rod drive housing tube. As a result, the elastic spring forces that assist the locking connection are advantageously increased further.

According to another preferred configuration, the pressure chamber of the locking ring is of annular construction. This results in a deformation that occurs uniformly over the entire circumference of the locking ring and leads to the contact wall being pressed on uniformly over the entire circumference of the control rod drive housing tube. As a result, the inner diameter of the locking ring is reduced uniformly. A particularly good locking connection is achieved.

According to another preferred configuration, the locking ring is assembled from a first part-ring and a second part-ring, forming the pressure chamber. As a result, the locking ring, in particular the locking ring with an annular pressure chamber, can be produced without great manufacturing outlay.

The object relating to the method is achieved, according to the invention, with regard to the method described in the introduction, by the fact that, in the vicinity of the threaded nut, a body is permanently attached to the control rod drive housing tube, as a result of a contact surface of the body being disposed so as to engage around the control rod drive housing tube, and as a result of a pressure chamber in the body being exposed to pressure in such a manner that the contact surface is pressed onto the control rod drive housing tube at least at certain locations.

Therefore, a permanent joint between the body and the control rod drive housing tube is achieved by the fact that, under the influence of the pressure in the pressure chamber, the contact surface is pressed onto the control rod drive housing tube, the constraining or opposing force which is always required for this purpose being produced by the fact that the body engages around the control rod drive housing tube.

After the pressure has been applied to the pressure chamber, the pressure on the pressure chamber can be relieved.

The pressure is in particular selected to be sufficiently great and is at least maintained sufficiently long to ensure that, even after the pressure on the pressure chamber has been relieved, permanent residual deformation of the body and, in particular, of the contact surface remains, in such a manner that the contact surface remains pressed onto the control rod drive housing tube.

In particular, when the contact surface is pressed onto the control rod drive housing tube, the latter is deformed, for example at least partially irreversibly. For this purpose, a particularly high pressure is established.

As has already been explained in connection with the locking ring according to the invention, the deformation may be elastic or plastic.

To apply pressure to the pressure chamber, the latter is preferably filled with fluid, in particular with a hydraulic fluid.

The pressure in the pressure chamber is preferably more than 1000 bar.

According to a preferred configuration of the method, the body is constructed as a locking ring. In particular, this locking ring is a locking ring according to the invention as described above.

The method according to the invention has the particular advantage that the body, in particular the locking ring, can easily be retrofitted to an existing control rod drive housing tube.

Other features that are considered as characteristic for the invention are set forth in the appended claims.

Although the invention is illustrated and described herein as embodied in a locking ring and a method for securing a control rod drive housing tube nut of a nuclear power plant, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a sectional view of a first exemplary embodiment of a locking ring mounted on a control rod drive housing tube;

FIG. 2 is a partial sectional view of the locking ring shown in FIG. 1;

FIG. 3 is a partial sectional view of a second embodiment of a locking ring;

FIG. 4 is a partial sectional view of a third embodiment of a locking ring; and

FIG. 5 is a partial sectional view of a fourth embodiment of a locking ring that includes a spring element.

### DESCRIPTION OF THE PREFERRED EMBODIMENTS

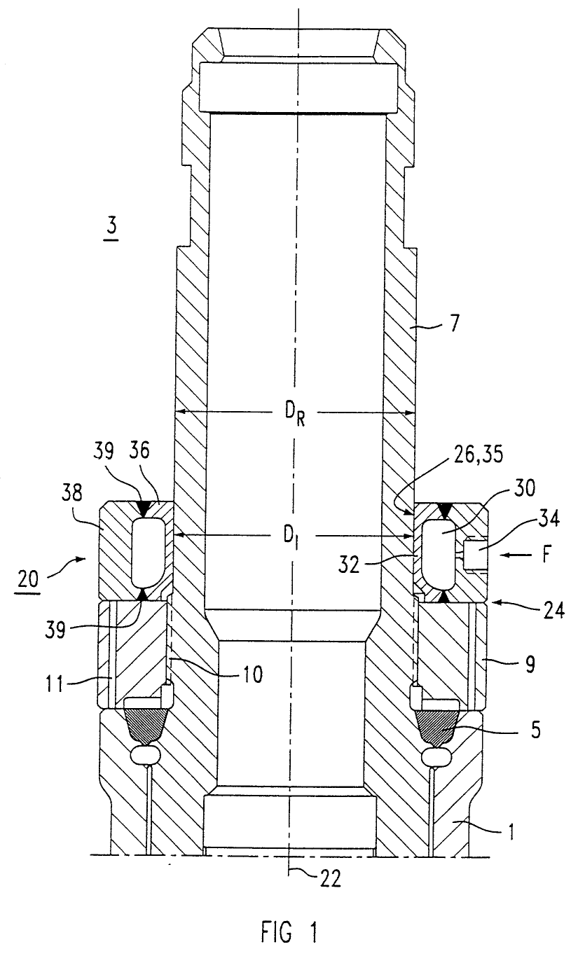

Referring now to the figures of the drawings in detail and first, particularly to FIG. 1 thereof, there is shown a circular nozzle 1 that projects into the interior 3 of a reactor pressure vessel (which is not otherwise illustrated) of a boiling water reactor. A control rod drive housing tube (AGR) 7, which is circular in cross section, is welded into the nozzle 1 by a welded joint 5. A control rod, which is not specifically illustrated, with a control rod guide tube, can be introduced through the control rod drive housing tube 7.

If one were to postulate a fracture of the welded joint 5, the control rod drive housing tube 7 would be forced downward out of the nozzle 1 at the reactor pressure vessel from the excess pressure prevailing in the interior 3. To prevent this, a threaded nut 9, which is known as a drive housing tube nut, is screwed onto the control rod drive housing tube 7 by an external screwthread 10 formed on the tube 7. The lower end side of the threaded nut 9 rests on the top side of the nozzle 1.

The threaded nut 9 has hitherto been secured by one or more cylindrical pins, which were guided through a bore 11 and were latched in the nozzle 1. Cylindrical pins of this type, which are not specifically illustrated, are difficult to retrofit, because appropriate blind bores have to be formed in the nozzle 1.

In FIG. 1, a locking ring 20 according to the invention is disposed on the control rod drive housing tube 7 to lock the threaded nut 9 in place. The locking ring 20 is disposed concentrically with respect to the axis 22 of the control rod drive housing tube 7 and, like the control rod drive housing tube 7, is preferably made from the material Austenite No. 4550. On its underside 24, it rests on threaded nut 9, so that the latter cannot become loose as a result of being screwed upward.

The inner lateral surface or outer side 26 of the locking ring 20 faces the drive housing tube 7. In the unlocked state, the inner diameter D_{I} (approx. 130 mm) of the locking ring 20 is only slightly greater than the outer diameter D_{R} 20 (approx. 129 mm) of the control rod drive housing tube 7, so that the locking ring 20 just still can be pushed onto this tube. The metallic locking ring 20 has an annular pressure chamber 30, which is disposed concentrically with respect to the locking ring 20 and the control rod drive housing tube 7.

The outer side 26 of a contact wall 32 of the pressure chamber 30 faces the control rod drive housing tube 7.

In order to lock the locking ring 20, the locking ring 20 is pushed onto the control rod drive housing tube 7 from the top until the position illustrated is reached. The pressure chamber 30 is filled with a fluid F via a filling flange 34 that is to be screwed on so that it is able to withstand high pressure and is exposed to a pressure p of approximately 1360 bar. As a result, the outer side 26 of the contact wall 32 is pressed onto the control rod drive housing tube 7. The outer side 26 of the locking ring 20 therefore forms a contact surface 35. In other words, the contact surface 35 of the contact wall 32 can be placed against the control rod drive housing tube 7 and can be deformed toward the latter.

The locking ring 20 is formed from a first part-ring 36 and a second part-ring 38, which are each U-shaped in cross section, are joined together by weld seams 39 and enclose the pressure chamber 30.

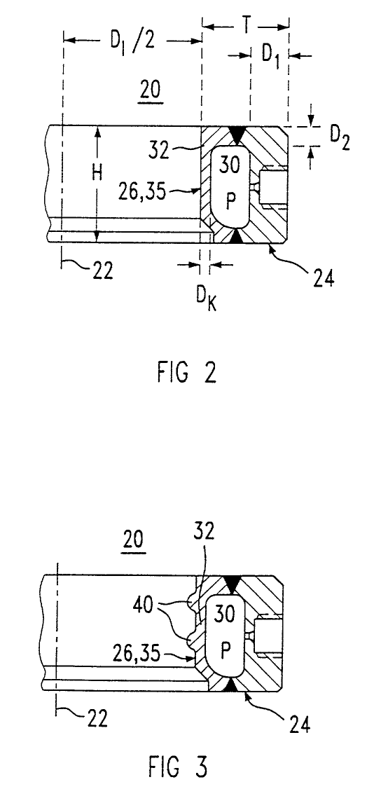

The locking ring 20 shown in FIG. 1 is illustrated in detail in FIG. 2. The height H of the locking ring 20 is approximately 50 mm. Its radial depth T is approximately 39 mm.

Compared to the contact wall 32, which has a lower wall thickness, the other walls of the pressure chamber 30 are of rigid and thick construction. The thickness D_{K} of the contact wall 32 is approximately 5 mm and is less than the thickness of all the other walls of the pressure chamber 30. In particular, the thickness D₁ of that wall of the pressure chamber 30 that is remote from the contact wall is approximately 16 mm, and the thickness D₂ of the upper and lower walls of the pressure chamber 30 is approximately 6 to 8 mm. When the pressure chamber 30 is exposed to the pressure p, the inner diameter D_{I} of the locking ring 20 is reduced, and the locking ring 20 is pressed under a radial force onto the control rod drive housing tube 7. At the same time, longitudinal deformation of the locking ring 20 occurs, so that an axial force also acts on the threaded nut 9 below it. As a result, the threaded nut 9 is locked in place securely by the locking ring 20.

After a time of a few minutes, the pressure in the pressure chamber 30 is relieved, and there remains a residual elastic deformation of the locking ring 20 that results in permanent locking.

FIG. 3 shows a second exemplary embodiment of a locking ring 20 according to the invention, in which the contact surface 26 has a molded projection 40 in the form of two lugs.

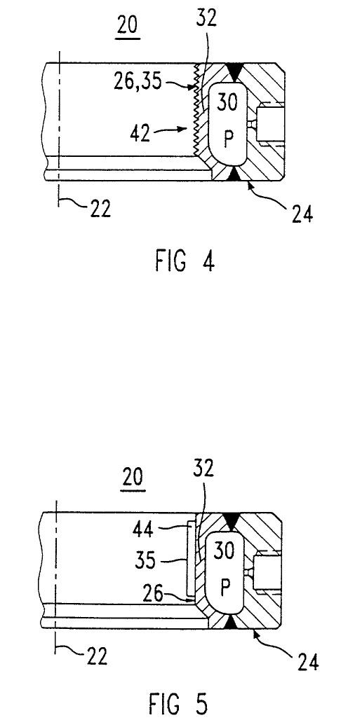

In the third exemplary embodiment shown in FIG. 4, the contact surface 26 has a profiling 42 that is particularly hardened.

The molded projection 40 and/or the profiling 42 form the contact surface 35 that acts on the control rod drive housing tube 7 and penetrate into the surface of the control rod drive housing tube 7 when pressure is applied to the pressure chamber 30.

In the exemplary embodiments that have been described thus far, the outer side 26 of the contact wall 32 comes to bear directly against the control rod drive housing tube 7, so that this outer side 26 is identical to the contact surface 35.

In the fourth exemplary embodiment, which is illustrated in FIG. 5, when the locking ring 20 has been pushed onto the control rod drive housing tube 7, a spring element 44 comes to lie between the outer side 26 and the control rod drive housing tube 7. In this case, the locking ring 20 bears on the control rod drive housing tube 7 indirectly, via the spring element 44. On its side that faces the axis 22, the spring element 44 has the contact surface 35. The spring element 44 is constructed, for example, as an undulating ring or a bar spring and increases the elastic forces that remain when the load on the pressure chamber 30 after the application of pressure is relieved again.

We claim:

1. A locking ring for a control rod drive housing tube of a nuclear power plant, comprising:
a first part-ring and a second part-ring welded together to form a pressure chamber to which pressure can be applied; and
a contact wall having an outer side facing the control rod drive housing tube and being pressed onto the control rod drive housing tube by the pressure;
said pressure chamber adjoining said contact wall and withstanding pressures greater than 1000 bar.

2. The locking ring according to claim 1, wherein:
said contact wall has a wall thickness; and
said pressure chamber has other walls each having a wall thickness greater than the wall thickness of said contact wall.

3. The locking ring according to claim 1, including a profiling disposed between said contact wall and the control rod drive housing tube.

4. The locking ring according to claim 3, wherein said profiling is a knurling.

5. The locking ring according to claims 1, including a molded projection disposed between said contact wall and the control rod drive housing tube.

6. The locking ring according to claim 5, wherein said molded projection is a lug.

7. The locking ring according to claim 1, including:
a filling flange being able to withstand the pressure; and
a fluid filling said pressure chamber.

8. The locking ring according to claim 7, wherein said fluid is hydraulic fluid.

9. The locking ring according to claim 1, including a spring element lying between said contact wall and the control rod drive housing tube.

10. The locking ring according to claim 1, wherein said pressure chamber is annular.

11. A method for securing a threaded nut of a control rod drive housing tube of a nuclear power plant, which comprises:
permanently attaching a body to the control rod drive housing tube near the threaded nut, the body having a pressure chamber and a contact surface for directly engaging the control rod drive housing tube;
engaging the contact surface of the body around the control rod drive housing tube; and
pressurizing the pressure chamber in the body to press the contact surface onto the control rod drive housing tube at least at certain locations.

12. The method according to claim 11, which further comprises deforming the control rod drive housing tube when the contact surface is pressed onto the control rod drive housing tube.

13. The method according to claim 11, which further comprises filling the pressure chamber with fluid.

14. The method according to claim 13, which further comprises using hydraulic fluid as the fluid.

15. The method according to claim 11, which further comprises pressurizing the pressure chamber to pressures greater than 1000 bar.

16. The method according to claim 11, utilizing a locking as the body.
